(19) United States
(12) Patent Application Publication
(10) Pub. No.: US 2025/0389698 A1
(43) Pub. Date: Dec. 25, 2025

(54) WIRELESS PASSIVE ULTRASOUND SENSOR ARRAY MONITORING SYSTEMS AND METHODS

(71) Applicants: HEFEI GENERAL MACHINERY RESEARCH INSTITUTE CO., LTD., Hefei, Anhui (CN); NATIONAL MACHINERY SPECIAL EQUIPMENT INSPECTION CO., LTD., Hefei (CN); HEFEI GENERAL MACHINERY RESEARCH INSTITUTE SPECIAL EQUIPMENT INSPECTION STATION OF CO., LTD., Hefei (CN)

(72) Inventors: Jingwei CHENG, Hefei (CN); Tian JI, Hefei (CN); Zhichao FAN, Hefei (CN); Xuedong CHEN, Hefei (CN); Wei CHEN, Hefei (CN); Yangguang BU, Hefei (CN); Xiangting XU, Hefei (CN)

(73) Assignees: HEFEI GENERAL MACHINERY RESEARCH INSTITUTE CO., LTD., Hefei (CN); NATIONAL MACHINERY SPECIAL EQUIPMENT INSPECTION CO., LTD., Hefei (CN); HEFEI GENERAL MACHINERY RESEARCH INSTITUTE SPECIAL EQUIPMENT INSPECTION STATION OF CO., LTD., Hefei (CN)

(21) Appl. No.: 19/295,678

(22) Filed: Aug. 10, 2025

Related U.S. Application Data
(63) Continuation-in-part of application No. PCT/CN2025/081804, filed on Mar. 11, 2025.

(30) Foreign Application Priority Data
Jun. 24, 2024 (CN) 202410815312.1

(51) Int. Cl. G01N 29/32; G01N 29/04

(52) U.S. Cl. CPC G01N 29/326; G01N 29/043

(57) ABSTRACT

The present disclosure relates to a wireless passive ultrasound sensor array monitoring system and method. The embodiments of the present disclosure design three sets of coils based on the principle of inductive coupling, i.e., sensor coils, transmitting coils, and receiving coils, which are respectively connected to ultrasound sensors, an output end of a controller, and an input end of the controller. Wireless signals and power may be transmitted between the sensor coils and the transmitting coils/receiving coils, thereby realizing wireless passive operation of the ultrasound sensors and improving detection efficiency. The embodiments of the present disclosure provide an m×n size ultrasound sensor array, combined with phased array technology and an imaging algorithm, for ultrasonic detection.

### CROSS-REFERENCE TO RELATED APPLICATIONS

This application is a Continuation-in-part of International Application No. PCT/CN2025/081804, filed on Mar. 11, 2025, which claims priority to Chinese Patent Application No. 202410815312.1, filed on Jun. 24, 2024, the entire contents of each of which are incorporated herein by reference.

### TECHNICAL FIELD

The present disclosure generally relates to the field of ultrasound measurement technology, and in particular, to a wireless passive ultrasound sensor array monitoring system and monitoring method.

### BACKGROUND

At present, the basic structure of the wireless passive sensor system based on inductive coupling is shown in FIG. 1. FIG. 1 is a first diagram illustrating a basic structure of a wireless passive sensor system based on inductive coupling according to the prior art. Two coils A and B are connected to a controller end, two coils C and D are connected to a sensor end, and the four coils are close to each other two-by-two and transmit signals/power based on the inductive coupling. The controller end transmits electrical energy through the coil A to the coil C to excite the sensor end to operate. Sensor signals are transmitted from the coil D to the coil B and returned to the controller end for signal processing. There is no need to connect wires between the sensor end and the controller end, and there is no need to install a power supply at the sensor end, forming a wireless passive sensor system. The inductive coupling refers to the fact that when an alternating current is passed through a coil, another coil close to the coil generates an induced current due to electromagnetic induction, which is said to be the inductive coupling between the two coils. Wireless transmission of the electrical signals between the two coils can be achieved based on this principle. The wireless passive refers to that the sensor end and the controller end are not connected by wires (i.e., wireless), and no power supply must be installed at the sensor end (i.e., passive).

An extension wire with coils at both ends may be inserted between controller coils and sensor coils to further develop a structure (as shown in FIG. 2) based on the basic structure of the wireless passive sensor system as shown in FIG. 1. FIG. 2 is a second diagram illustrating a basic structure of a wireless passive sensor system based on inductive coupling according to the prior art.

Phased array ultrasonic detection refers to an advanced ultrasonic wave detection manner that can be applied to medical imaging and industrial non-destructive detection. An ordinary ultrasonic probe only emits an ultrasonic beam in a fixed direction, and the detection process must be done by moving or rotating the probe so that the ultrasonic beam sweeps across an area to be detected. In contrast, the ultrasonic beam emitted by a phased array probe can be controlled by circuitry to achieve focusing and scanning without moving the probe.

The phased array probe is composed of an ordinary ultrasound sensor array, and each array element may independently transmit ultrasonic excitation signals and receive echo signals according to the time set by the controller. Compared with detection technology based on the ordinary ultrasound sensor, existing phased array ultrasonic detection technology based on the ordinary ultrasound sensor array has the advantage of being able to perform defect imaging, achieve defect location, quantification, and characterization, etc., and also detect pieces difficult to detect with complex shapes. However, the existing phased array ultrasonic detection technology also has the following shortcomings. 1. It is necessary to employ wires to connect the phased array probe and the controller, and a size of the phased array probe is large. As a result, each detection requires the detector to hold the phased array probe or to employ a scanner to scan the position to be tested, which is inconvenient to detect in narrow gaps and other positions. 2. During the detection process, the defect position is unknown, and the surface of the area to be detected needs to be scanned with the phased array probe, which places high demands on the detection speed. For this reason, the controller of the existing phased array employs a plurality of parallel channels to simultaneously transmit and receive a plurality of array element signals. For example, for an 8×8 phased array probe, there are 64 channels in total, which requires 64 parallel channels of wires and controllers for control. The use of a large number of independently controlled channels makes the phased array detection device expensive and greatly increases the calibration and maintenance costs.

### SUMMARY

One or more embodiments of the present disclosure provide a wireless passive ultrasound sensor array monitoring system, comprising: a sensor module, a signal transmitting module, a signal receiving module, and a controller.

The sensor module includes a sensor end and a sensor coil end. The sensor end is arranged with an ultrasound sensor array, the sensor coil end is arranged with a sensor coil array, a size of the ultrasound sensor array is the same as a size of the sensor coil array, and ultrasound sensors in the ultrasound sensor array and sensor coils in the sensor coil array at corresponding positions are connected one by one.

The signal transmitting module includes a transmitting coil end. The transmitting coil end is arranged with a transmitting coil array, a size and an arrangement of the transmitting coil array is the same as the size and an arrangement of the sensor coil array, and transmitting coils in the transmitting coil array and the sensor coils in the sensor coil array are one by one correspond in a vertical direction. Leads of the transmitting coils in the transmitting coil array are all connected to the controller.

The signal receiving module includes a receiving coil end. The receiving coil end is arranged with a receiving coil array, a size and an arrangement of the receiving coil array is the same as the size and the arrangement of the sensor coil array, and receiving coils in the receiving coil array and the sensor coils in the sensor coil array are one by one correspond in the vertical direction. Leads of the receiving coils in the receiving coil array are all connected to the controller

A set of a sensor coil, a transmitting coil, and a receiving coil corresponding in the vertical direction constitute a channel. The channel is configured to transmit or receive a signal.

The controller employs phased array ultrasonic detection, and generates excitation signals and collects and analyzes echo signals.

The sensor end of the sensor module is affixed to a surface of a structure to be tested. The sensor coil end, the transmitting coil end, and the receiving coil end are in close proximity to each other, and center positions of the set of the sensor coil, the transmitting coil, and the receiving coil corresponding in the vertical direction correspondingly coincide one by one in the vertical direction, realizing ultrasonic detection of the structure to be tested.

One or more embodiments of the present disclosure provide a wireless passive ultrasound sensor array monitoring method based on the wireless passive ultrasound sensor array monitoring system. The wireless passive ultrasound sensor array monitoring method comprises the following S.

S1, affixing and securing the sensor end of the sensor module to the surface of the structure to be tested.

S2, placing the sensor coils of the sensor module, the transmitting coils of the signal transmitting module, and the receiving coils of the signal receiving module one by one in the vertical direction and in close proximity. The leads of the transmitting coils and the leads of the receiving coils are connected to the controller.

The sensor coil array, the transmitting coil array, and the receiving coil array are all of size m×n, constituting m×n channels.

S3, generating the excitation signals by the controller in a preset manner, transmitting the excitation signals from the transmitting coils to the sensor coils, exciting the ultrasound sensors to operate to emit ultrasonic waves by the sensor coils; and receiving the echo signals by the ultrasound sensor, transmitting the echo signals from the sensor coils to the receiving coils, to obtain the echo signals.

### BRIEF DESCRIPTION OF THE DRAWINGS

FIG. 1 is a first diagram illustrating a basic structure of a wireless passive sensor system based on inductive coupling according to the prior art.

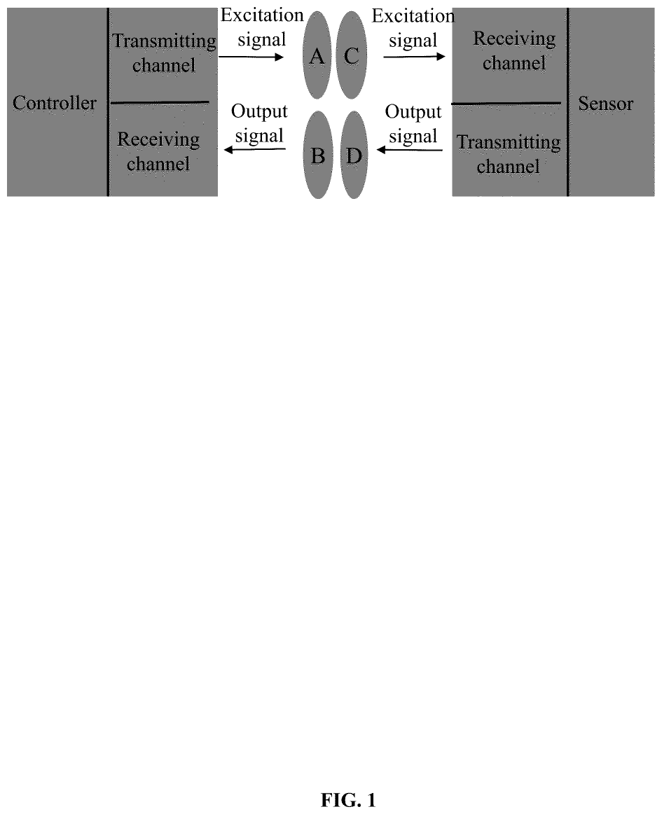

FIG. 2 is a second diagram illustrating a basic structure of a wireless passive sensor system based on inductive coupling according to the prior art.

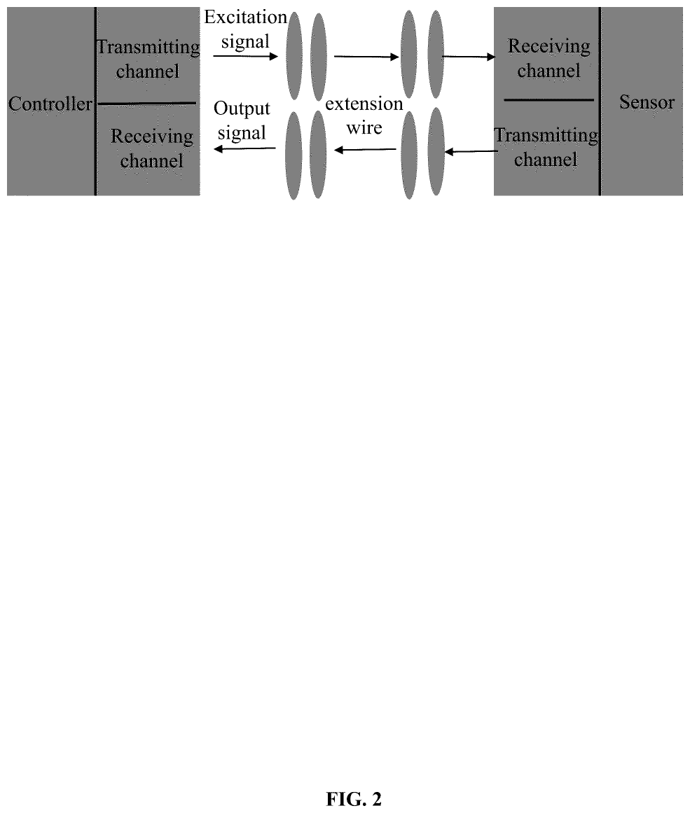

FIG. 3 is a diagram illustrating a structure of a wireless passive ultrasound sensor array monitoring system according to some embodiments of the present disclosure.

FIG. 4 is a front view schematic diagram of a sensor module according to some embodiments of the present disclosure.

FIG. 5 is a rear view schematic diagram of a sensor module according to some embodiments of the present disclosure.

FIG. 6 is a front view schematic diagram of a signal transmitting module according to some embodiments of the present disclosure.

FIG. 7 is a rear view schematic diagram of a signal transmitting module according to some embodiments of the present disclosure.

FIG. 8 is a front view schematic diagram of a signal receiving module according to some embodiments of the present disclosure.

FIG. 9 is a rear view schematic diagram of a signal receiving module according to some embodiments of the present disclosure.

FIG. 10 is a schematic diagram illustrating an installation of a wireless passive ultrasound sensor array monitoring system according to some embodiments of the present disclosure.

FIG. 11 is total-focus images according to some embodiments of the present disclosure; (a) denotes an initial (first detection) total-focus image obtained, (b) denotes a total-focus image obtained after 1 year, and (c) denotes a processed image obtained based on baseline subtraction.

### DESCRIPTION OF THE ACCOMPANYING MARKINGS

1—sensor module, 2—signal transmitting module, 3—signal receiving module, 4—controller, 5—wrapper layer, 6—structure to be tested.
11—sensor end, 111—ultrasound end lead hole, 112—ultrasound front lead, 113—ultrasound sensor, 114—ultrasound back lead, 12—first connector, 121—first front connection wire, 122—first back connection wire, 13—sensor coil end, 131—sensor coil, 132—sensor front lead, 133—sensor end lead hole, 134—sensor back lead.
21—transmitting coil end, 211—transmitting coil, 212—transmitting front lead, 213—transmitting end lead hole, 214—transmitting back lead, 22—second connector, 221—second front connection wire, 222—second back connection wire, 23—transmitting lead end, 231—front transmitting pad lead, 232—front transmitting pad, 233—back transmitting pad lead, 234—back transmitting pad.
31—receiving coil end, 311—receiving coil, 312—receiving front lead, 313—receiving end lead hole, 314—receiving back lead, 32—third connector, 321—third front connection wire, 322—third back connection wire, 33—receiving lead end, 331—front receiving pad lead, 332—front receiving pad, 333—back receiving pad lead, 334—back receiving pad

### DETAILED DESCRIPTION

The technical solutions in the embodiments of the present disclosure will be clearly and completely described below in conjunction with the accompanying drawings in the embodiments of the present disclosure, and it is clear that the embodiments described are only a portion of the embodiments of the present disclosure, and not all of the embodiments. Based on the embodiments in the present disclosure, all other embodiments obtained by those skilled in the art without making creative labor fall within the scope of protection of the present disclosure.

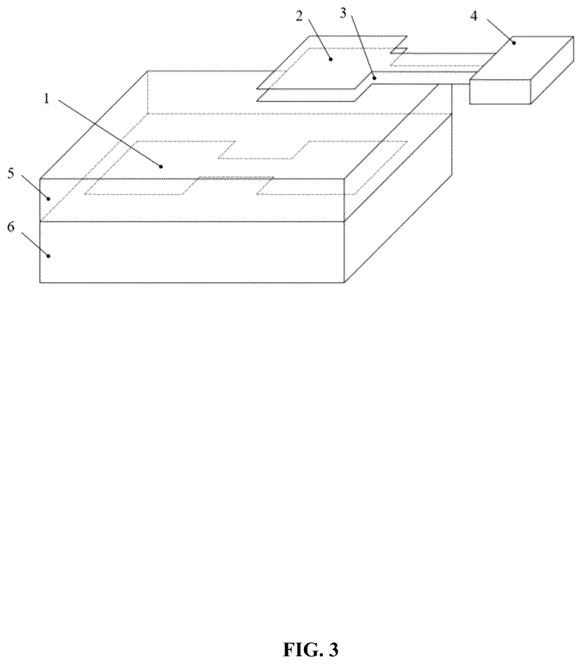

FIG. 3 is a diagram illustrating a structure of a wireless passive ultrasound sensor array monitoring system according to some embodiments of the present disclosure.

As shown in FIG. 3, some embodiments of the present disclosure provide a wireless passive ultrasound sensor array monitoring system including a sensor module 1, a signal transmitting module 2, a signal receiving module 3, and a controller 4.

The sensor module refers to a module for transmitting ultrasonic waves and receiving echo signals. In some embodiments, the sensor module 1 emits the ultrasonic waves based on signals transmitted by the signal transmitting module 2 and transmits the echo signals to the signal receiving module 3. The signal transmitting module 2 refers to a module for receiving excitation signals from the controller 4 and transmitting the excitation signals to the sensor module 1. The signal receiving module 3 refers to a module for receiving the echo signals transmitted by the sensor module 1 and transmitting the echo signal to the controller 4. The controller refers to a device that generates the excitation signals and collects, records, and analyzes the echo signals in a preset manner. More descriptions regarding the specific structures of the sensor module 1, the signal transmitting module 2, the signal receiving module 3, and the controller 4 may be found in the related descriptions below.

In some embodiments, the sensor module 1, the signal transmitting module 2, and the signal receiving module 3 are all sheet-like structures. The controller 4 may be obtained by assembling a phased array ultrasound board card available on the market with a channel switching circuit.

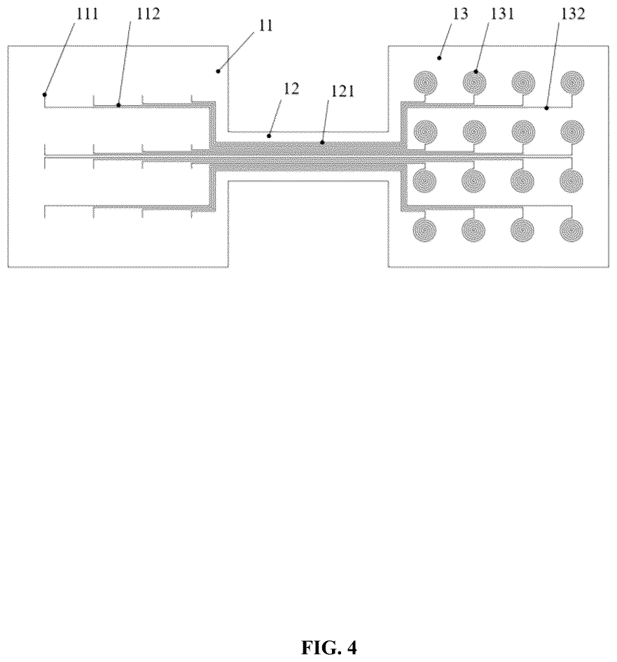

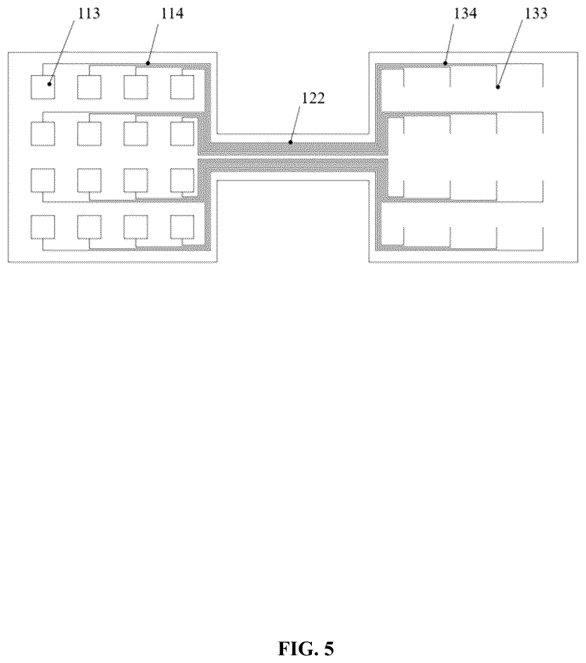

FIG. 4 is a front view schematic diagram of a sensor module according to some embodiments of the present disclosure. FIG. 5 is a rear view schematic diagram of a sensor module according to some embodiments of the present disclosure.

As shown in FIGS. 4 and 5, the sensor module 1 includes a sensor end 11 and a sensor coil end 13. The sensor end 11 is arranged with an array of ultrasound sensors 113 (referred to as an ultrasound sensor array), and the sensor coil end 13 is arranged with an array of sensor coils 131 (referred to as a sensor coil array). The array of the ultrasound sensors 113 and the array of sensor coils 131 are of the same scale, and the ultrasound sensors 113 and the sensor coils 131 at corresponding positions are connected one-to-one.

The sensor end refers to a portion that is configured to emit the ultrasonic waves and receive the ultrasonic waves. The ultrasound sensor refers to a device that emits high-frequency sound waves (frequency>20 kHz) and receives the echo signals. The ultrasound sensor can realize the two-way conversion of sound waves and electrical signals. As an example, the ultrasound sensor may include a piezoelectric chip transducer, a capacitive micromachined ultrasound transducer, a piezoelectric micromachined ultrasound transducer, etc. The sensor coil end refers to a portion that is configured to receive the excitation signals and excite the sensor end, to receive the echo signals transmitted from the sensor end, and to transmit the echo signals to the receiving coil end. The sensor coil refers to a device designed based on the principle of electromagnetic induction. It is usually wound with conductive materials and can convert physical quantities (such as current and magnetic field changes) into electrical signals. The ultrasound sensor array refers to an array of a plurality of ultrasound sensors arranged in a regular rule. In some embodiments, the plurality of ultrasound sensors are arranged on a substrate to form an array according to a regular rule. The sensor coil array refers to an array of a plurality of sensor coils arranged in a regular rule. In some embodiments, the plurality of sensor coils are arranged on a substrate to form an array according to a regular rule. More descriptions regarding the substrate may be found elsewhere in the present disclosure.

The same array size (or scale) refers to that the array of the ultrasound sensors 113 and the array of sensor coil 131 are completely identical in terms of a count of units and arrangement (such as a count of rows and columns). In some embodiments, the array of ultrasound sensors 113 is of the same size as the array of sensor coils 131, and each ultrasound sensor is connected to a corresponding sensor coil.

In some embodiments, the scale of the array of ultrasound sensors 113 and the array of sensor coils 131 may be m×n, where m denotes an integer greater than or equal to 2, n denotes an integer greater than or equal to 2, and m and n may be the same or different. FIGS. 4 and 5 show a 4×4 array as an example.

In some embodiments, the ultrasound sensor 113 and the sensor coil 131 are connected as shown below. The sensor end 11 and the sensor coil end 13 are connected by a first connector 12. Each ultrasound sensor 113 of the ultrasound sensor array and each sensor coil 131 of the sensor coil array has two leads, and the two leads are arranged on a front side and a back side of the sensor module 1, respectively. An ultrasound front lead 112 of the ultrasound sensor 113 is connected to a sensor front lead 132 of the sensor coil 131 via a first front connection wire 121. An ultrasound back lead 114 of the ultrasound sensor 113 is connected to a sensor back lead 134 of the sensor coil 131 via a first back connection wire 122. The sensor end 11 is provided with a plurality of ultrasound end lead holes 111 for the ultrasound front lead 112 or the ultrasound back lead 114 of the ultrasound sensor 113 to pass through. The sensor coil end 13 is provided with a plurality of sensor end lead holes 133 for the sensor front lead 132 or the sensor back lead 134 of the sensor coil 131 to pass through. The first connector 12 includes the first front connection wire 121 and the first back connection wire 122.

In some embodiments, the signal transmitting module includes a transmitting coil end. The transmitting coil end is arranged with a transmitting coil array, a size and an arrangement of the transmitting coil array is the same as a size and an arrangement of the sensor coil array, and transmitting coils in the transmitting coil array and the sensor coils in the sensor coil array are one by one correspond in a vertical direction. Leads of the transmitting coils in the transmitting coil array are all connected to a controller.

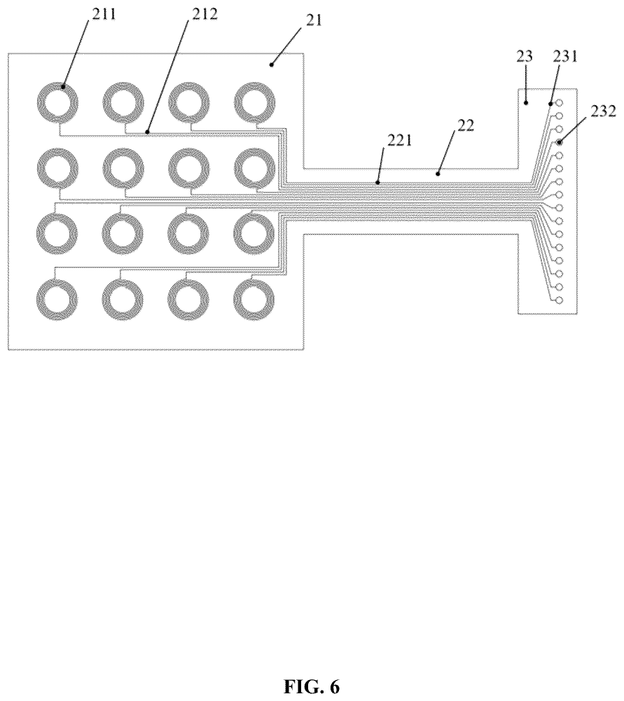

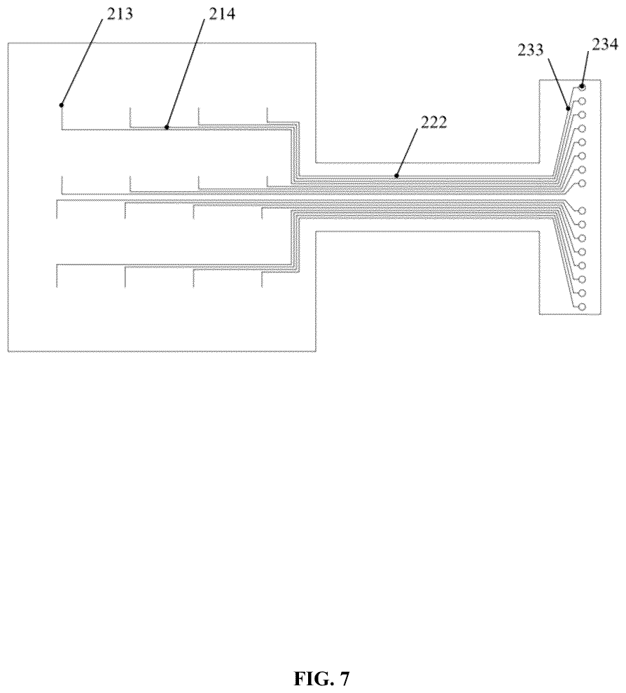

FIG. 6 is a front view schematic diagram of a signal transmitting module according to some embodiments of the present disclosure. FIG. 7 is a rear view schematic diagram of a signal transmitting module according to some embodiments of the present disclosure.

As shown in FIGS. 6 and 7, the signal transmitting module 2 includes a transmitting coil end 21 and a transmitting lead end 23. The transmitting coil end 21 is arranged with an array of transmitting coils 211 (referred to as a transmitting coil array), a size of the array of the transmitting coils 211 (e.g., m×n) is the same as a size of an array of sensor coils 131 and is arranged in the same manner, i.e., at the same intervals, and the transmitting coils in the transmitting coil array and the sensor coils in the sensor coil array are one by one correspond in a vertical direction.

The transmitting coil end refers to a portion that is configured to receive excitation signals from the controller and transmit the excitation signals (based on electromagnetic induction) to the sensor coil end. The transmitting coil refers to a component that generates an alternating magnetic field based on electromagnetic induction, which is configured to convert electrical energy into magnetic field energy and transmit the magnetic field energy outward. The transmitting coil is usually wound from a conductive material. The transmitting coil array refers to an array of a plurality of transmitting coils arranged in a regular rule. In some embodiments, the plurality of transmitting coils are arranged on a substrate to form an array according to a regular rule. More descriptions regarding the substrate may be found elsewhere in the present disclosure. The transmitting lead end refers to a portion that is configured to electrically connect the transmitting coil end 21 to the controller 4. The lead of the transmitting coil refers to a wire or line that is configured to connect the transmitting coil and the transmitting lead end 23.

The leads of the plurality of transmitting coils 211 of the signal transmitting module 2 are led through the transmitting lead end 23. A set (e.g., a plurality) of pads is arranged on the front and back sides of the transmitting lead end 23, respectively. The set of pads arranged on the front side of the transmitting lead end 23 is a front transmitting pad 232, and the set of pads arranged on the back side of the transmitting lead end 23 is a back transmitting pad 234. The pad refers to a metalized area on an electronic substrate used for electrical connection and mechanical fixation. The transmitting coil end 21 is connected to the transmitting lead end 23 by a second connector 22. A count of the transmitting coils 211 is the same as both a count of the front transmitting pads 232 and a count of the back transmitting pads 234. Each of the transmitting coils 211 includes a front lead and a back lead respectively, and the front lead is a transmitting front lead 212, and the back lead is a transmitting back lead 214. The transmitting front lead 212 and the transmitting back lead 214 are configured to connect to the front transmitting pad 232 and the back transmitting pad 234, respectively. The transmitting front lead 212 of the transmitting coil 211 is connected to the front transmitting pad lead 231 of the front transmitting pad 232 through a second front connection wire 221. The transmitting back lead 214 of the transmitting coil 211 is connected to the back transmitting pad lead 233 of the back transmitting pad 232 through a second back connection wire 222. The transmitting coil end 21 is provided with a plurality of transmitting end lead holes 213 for allowing the transmitting front lead 212 or the transmitting back lead 214 of the transmitting coils 211 to pass through. The second connector 22 includes the second front connection wire 221 and the second back connection wire 222.

In some embodiments, reliable electrical signal transmission is achieved by combining the transmitting lead end 23, the receiving lead end 33, the front transmitting pad 232, the back transmitting pad 234, the front receiving pad 332, and the back receiving pad 334.

In some embodiments, the signal receiving module includes a receiving coil end. The receiving coil end is arranged with a receiving coil array, a size and an arrangement of the receiving coil array is the same as a size and an arrangement of the sensor coil array, and the receiving coils in the receiving coil array and the sensor coils in the sensor coil array are one by one correspond in a vertical direction. Leads of the receiving coils in the receiving coil array are all connected to the controller.

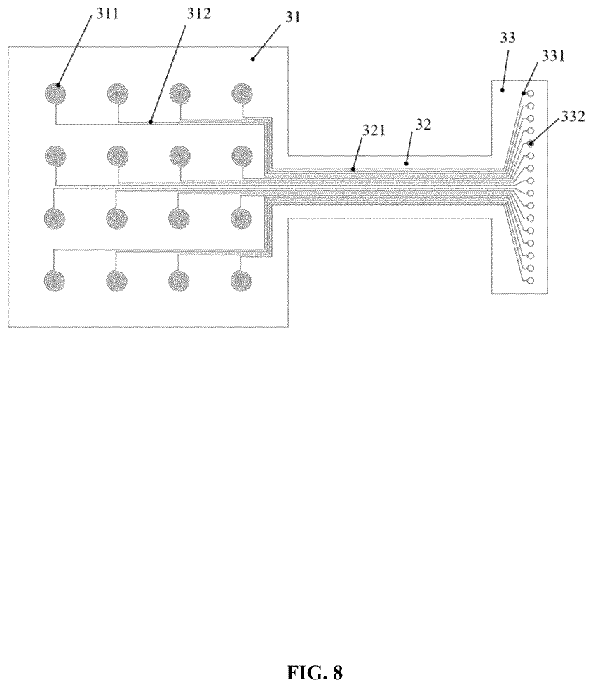

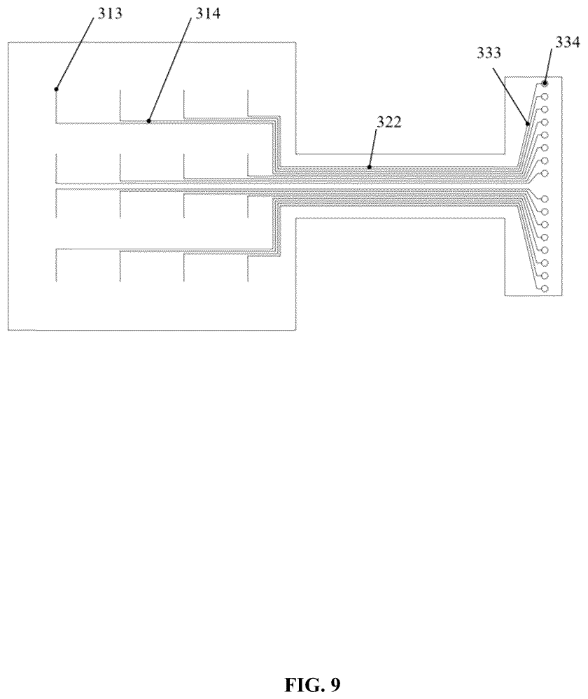

FIG. 8 is a front view schematic diagram of a signal receiving module according to some embodiments of the present disclosure. FIG. 9 is a schematic diagram of a signal receiving module according to some embodiments of the present disclosure.

As shown in FIGS. 8 and 9, an overall structure of the signal receiving module 3 is the same as an overall structure of the signal transmitting module 2. The signal receiving module 3 includes a receiving coil end 31 and a receiving lead end 33. The difference between the signal receiving module 3 and the signal transmitting module 2 is that specifications (e.g., a diameter, a count of turns, etc.) of the receiving coil 311 on the receiving coil end 31 of the signal receiving module 3 are different from specifications of the transmitting coil 211, and the arrangement of the rest of the parts is the same. Center positions of the receiving coils 311 and the transmitting coils 211 correspond one by one. The receiving coil end 31 is arranged with an array of the receiving coils 311 (referred to as a receiving coil array). A size of the array of the receiving coils 311 (e.g., m×n) is the same as a size of the array of the sensor coils 131 and is arranged in the same manner, i.e., at the same intervals, and the receiving coils in the receiving coil array and the sensor coils in the sensor coil array are one by one correspond in a vertical direction.

The receiving coil end refers to a portion that is configured to receive echo signals transmitted from the sensor coil end and to transmit the echo signals to the controller. The receiving coil refers to a component that captures the echo signals based on the principle of electromagnetic induction. The receiving coils may amplify a weak induced current and transmit the amplified induced current to the controller. The receiving coil may employ shielding materials and a low impedance structure. The receiving coil array refers to an array of a plurality of receiving coils arranged in a regular rule. In some embodiments, the plurality of receiving coils are arranged on a substrate to form an array according to a regular rule. More descriptions regarding the substrate may be found in the related descriptions below. The receiving lead end refers to a portion that is configured to electrically connect the receiving coil end 21 and the controller 4. The lead of the receiving coil refers to a wire or line that connects the receiving coil and the receiving lead end 23.

In some embodiments, leads of the plurality of transmitting coils of the signal transmitting module are all led through a transmitting lead end. The transmitting lead end is provided with a plurality of front transmitting pads and a plurality of back transmitting pads corresponding to a count of the transmitting coils. The transmitting front leads and the transmitting back leads of the plurality of transmitting coils are connected to the plurality of front transmitting pads and the plurality of back transmitting pads. The leads of the plurality of receiving coils of the signal receiving module are all led through a receiving lead end, and the receiving lead end is provided with a plurality of front receiving pads and a plurality of back receiving pads corresponding to a count of the receiving coils. Receiving front leads and receiving back leads of the plurality of receiving coils are connected to the plurality of front receiving pads and the plurality of back receiving pads.

In some embodiments, the leads of the plurality of receiving coils 311 of the signal receiving module 3 are all led through the receiving lead end 33. A set (e.g., a plurality) of pads is arranged on the front and back sides of the receiving lead end 33, respectively. The set of pads arranged on the front side of the receiving lead end 33 is a front receiving pad 332, and the set of pads arranged on the back side of the receiving lead end 33 is a back receiving pad 334. A count of the receiving coils 211 is the same as both a count of the front receiving pads 232 and a count of the back receiving pads 234. Each receiving coil 311 includes a front lead and a back lead, respectively, and the front lead is a receiving front lead 312, and the back lead is a receiving back lead 314. The receiving front lead 312 and the receiving back lead 314 are configured to connect to the front receiving pad 332 and the back receiving pad 334, respectively. The receiving front lead 312 of the receiving coil 311 is connected to a front receiving pad lead 331 of the front receiving pad 332 via a third front connection wire 321. The receiving back lead 314 of the receiving coil 311 is connected to a back receiving pad lead 333 of the back receiving pad 334 via a third back connection wire 322. The receiving coil end 31 is provided with a plurality of receiving end lead holes 313 for allowing the receiving front lead 312 or the receiving back lead 314 of the receiving coils 311 to pass through. The third connector 32 includes the third front connection wire 321 and the third back connection wire 322.

As shown in FIG. 3, an installation manner of the system in the embodiment of the present disclosure is to affix the sensor module 1 to the surface of the structure to be tested 6, and the signal receiving module 3 and the signal transmitting module 2 are stacked together and connected to the controller 4. The positions of the signal receiving module 3 and the signal transmitting module 2 may be interchanged up and down.

In some embodiments, the sensor coil end 13 of the sensor module 1 is affixed to the surface of the structure to be tested 6. All three of the sensor coil end 13, the transmitting coil end 21 of the signal transmitting module 2, and the receiving coil end 31 of the signal receiving module 3 are in close proximity to each other, and center positions of a set of a sensor coil 131, a transmitting coil 211, and a receiving coil 311 corresponding in the vertical direction correspondingly coincide one by one in the vertical direction, realizing ultrasonic detection of the structure to be tested.

In a working state, a wrapper layer 5 of a certain thickness may be placed between the sensor module 1 and the signal transmitting module 2 or the signal receiving module 3 to realize ultrasonic detection through the wrapper layer 5.

The wrapper layer 5 refers to a structure that is configured to wrap the structure to be tested 6, which can play a protective role.

In some embodiments, the array of the ultrasound sensors 113, the array of the transmitting coils 211, and the array of the receiving coils 311 are all of size m×n.

In some embodiments, three sets of coils are designed based on the principle of inductive coupling, i.e., the sensor coils, the transmitting coils, and the receiving coils, which are respectively connected to the ultrasound sensor, an output end of the controller, and an input end of the controller. Wireless signals and power may be transmitted between the sensor coils and the transmitting coils/receiving coils, thereby realizing wireless passive operation of the sensor. This design greatly simplifies the structure of the sensor end, and there is no need to connect a power supply or design a battery, which reduces the difficulty of explosion-proof design, avoids a series of failure risks caused by factors such as circuit sealing, circuit aging, battery replacement or charging, and enhances the safety and stability of the sensor end. At the same time, due to the wireless connection, the echo signals of the ultrasound sensor can be collected only by aligning and bringing the coils close to each other, and setting the channels into an array of a certain size improves the detection efficiency.

In some embodiments, the channel is set up as an array of a certain size, specifically may be set up as an ultrasound sensor array of m×n size, which can be applied to phased array ultrasonic detection. Combining phased array technology and imaging algorithms, not only can achieve more accurate thickness measurement through mutual transmission and reception verification between a plurality of array elements, but also realize the defect imaging function of an area where the ultrasound sensor array is affixed, and cover the monitoring needs of cracks, pinhole corrosion and other non-uniform defects, broadening the application field of the wireless passive sensor.

In some embodiments, compared with ordinary wired sensors, the wireless passive ultrasound sensor array monitoring system has the following main advantages. 1. The monitoring device, composed of the signal transmitting module, the signal receiving module, and the controller, does not require a wire connection with the sensor end. Moreover, as electromagnetic fields can penetrate the vast majority of non-metallic materials, it is possible to conduct detection through structures such as wrapper layers between the sensor and the monitoring device, which can be applied to some situations where direct detection by conventional detection equipment is inconvenient. 2. No power supply needs to be installed at the sensor end, which greatly simplifies the structure of the sensor end and avoids various faults and risks caused by batteries at the same time. 3. The sensor end has a simple structure and is easy to seal, making the sensor end suitable for operating in humid environments or even underwater.

In some embodiments, an outer diameter of the receiving coil 311 is smaller than an inner diameter of the transmitting coil 211, or an outer diameter of the transmitting coil 211 is smaller than an inner diameter of the receiving coil 311. The above structural arrangement can ensure that the receiving coil 311 and the transmitting coil 211 do not overlap in the vertical direction, thereby reducing mutual interference during signal transceiver. In the embodiments corresponding to FIGS. 6 and 8, the outer diameter of the receiving coil 311 is smaller than the inner diameter of the transmitting coil 211.

Lines (e.g., leads and connection wires) arranged on the front and back sides of the sensor module 1, the signal transmitting module 2, and the signal receiving module 3 are staggered and do not overlap, thereby reducing the difficulty of processing and improving the structural reliability of the device.

In some embodiments, the wireless passive ultrasound sensor array monitoring system further includes a temperature sensor configured to collect temperature information and send the temperature information to the controller 4. The wireless passive ultrasound sensor array monitoring system (e.g., the controller 4) is configured to perform real-time sound velocity correction based on the temperature information.

In some embodiments, the sensor end 11 of the sensor module 1 is additionally provided with the temperature sensor. In some embodiments, the surface of the structure to be tested 6 and the surface of the wrapper layer 5 are provided with the temperature sensor. In some embodiments, the temperature sensor is provided in the controller 4. The temperature sensor refers to a device that may sense temperature changes and convert the temperature changes into quantifiable electrical signals (such as voltage, current, or resistance). The temperature sensor may include a thermistor-type sensor, a thermocouple-type sensor, a platinum RTD-type sensor, an infrared temperature measurement sensor, an integrated temperature and humidity sensor, or the like.

The configuration of the temperature sensor can improve the accuracy of detection.

In some embodiments, the relationship between temperature and the propagation velocity of the ultrasonic wave in a material can be used to adjust the sound velocity parameters and perform sound velocity correction.

In some embodiments, an electromagnetic shielding material is affixed to a side of the sensor coil 13 facing the structure to be tested 6. The electromagnetic shielding material can suppress the eddy current in the metal caused by the current in the sensor coil 131 when the monitoring system detects a metal structure, reduce energy loss, and improve the signal-to-noise ratio.

The electromagnetic shielding material refers to a functional material that can effectively suppress external electromagnetic interference or internal signal leakage by reflecting, absorbing, or guiding electromagnetic waves. In some embodiments, the electromagnetic shielding material may include a metal foil, graphene-doped coating, or the like.

In some embodiments, the sensor module 1, the signal transmitting module 2, and the signal receiving module 3 all designate a non-metallic material as a substrate.

The non-metallic material refers to a type of material that does not contain metal elements or has extremely low metal content. The physical and chemical properties of the non-metallic material are mainly insulation, low conductivity, and low magnetic permeability. The non-metallic material is suitable for electronic equipment substrate that is sensitive to electromagnetic interference and requires lightweight or corrosion resistance. In some embodiments, the non-metallic material may include a ceramic material or a thin film material. The substrate refers to a bottom structure in a material or device that serves as a support, load-bearing, or fixing function.

In some embodiments, the sensor module 1 selects the non-metallic material as the substrate, which can avoid energy loss caused by eddy currents in the substrate material caused by the alternating current in the sensor coil 131 during the signal transceiver, while reducing the risk of short circuits in the first connector 12, the ultrasound sensor 113, and the sensor coil 131 loops. In some embodiments, a thin film material may be employed as the substrate, so that the substrate can be bent within a certain range and better fit the surface (e.g., a cylindrical outer wall of a pressure vessel or a pressure pipe) of the structure to be tested 6. As an example, the substrate may be Polyimide (PI) film. The connecting wires and the sensor coil 131 may be manufactured using a flexible printed circuit (FPC) process. The ultrasound sensor 113 with a relatively small thickness (e.g., the piezoelectric chip transducer, the capacitive micromachined ultrasound transducer, and the piezoelectric micromachined ultrasound transducer) are selected to form an m×n size ultrasound sensor array to ensure that the overall thickness of the sensor module 1 is relatively small and can work normally under various wrapper layers 5 without affecting the closure of the wrapper layers 5 or causing stress concentration in an outer layer. The outer layer refers to the outermost layer of the wrapper layer 5.

In some embodiments, the signal transmitting module 2 and the signal receiving module 3 are selected with a non-metallic material substrate to avoid energy loss or electromagnetic shielding effect caused by eddy currents in the substrate material caused by the alternating current in the coil during the signal transceiver. The vertical positions of the signal transmitting module 2 and the signal receiving module 3 may be interchanged without affecting the monitoring process.

The signal transmitting module 2, the signal receiving module 3, and the controller 4 are combined to form a monitoring device. The controller 4 is internally installed with a battery or is connected to a power source. The circuitry of the signal transmitting module 2 is led through the front transmitting pad 232 and the back transmitting pad 234 of the transmitting lead end 23, and the circuitry of the signal receiving module 3 is similarly led through the front receiving pad 332 and the back receiving pad 334 of the receiving lead end 33.

In some embodiments, a set of the sensor coil 131, the transmitting coil 211, and the receiving coil 311 corresponding in the vertical direction constitutes a channel. The channel is configured to transmit or receive signals, and ultimately constitutes m×n channels.

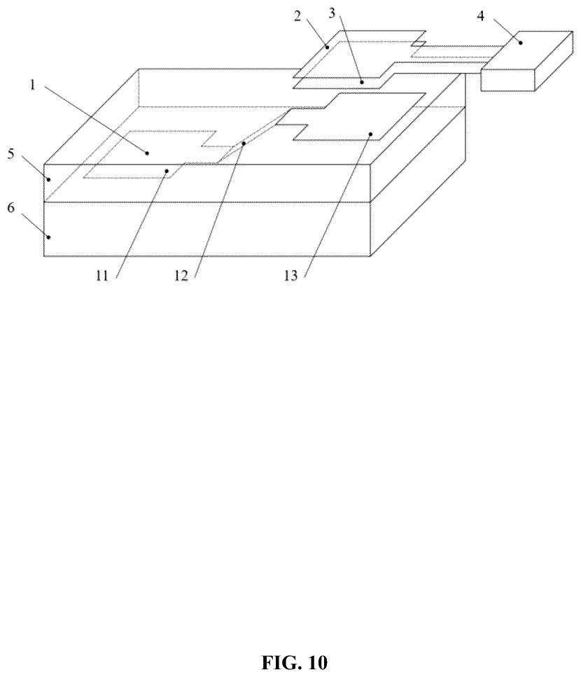

FIG. 10 is a schematic diagram illustrating an installation of a wireless passive ultrasound sensor array monitoring system according to some embodiments of the present disclosure.

As shown in FIG. 10, when the sensor module 1 is installed, the sensor end 11 needs to be closely attached to the surface of the structure to be tested 6 and fixed to ensure good coupling between the interfaces, while the installation positions of the first connector 12 and the sensor coil end 13 can be changed. In some specific cases, the installation manner shown in FIG. 3 is difficult to meet the use requirements. For example, the thickness of the wrapper layer 5 is too large, which reduces the inductive coupling effect and the signal-to-noise ratio, affecting the detection effect. The wrapper layer 5 contains a conductive layer, which also plays an electromagnetic shielding role, reduces the inductive coupling power/signal transmission efficiency, and makes it difficult to obtain effective detection data. At this time, the first connector 12 may be extended from the wrapper layer 5 in the manner shown in FIG. 10, and the sensor coil end 13 may be installed outside the wrapper layer 5. During the ultrasonic detection, the coil ends corresponding to the signal transmitting module 2 and the signal receiving module 3 of the monitoring device can be closely fitted with the sensor coil end 13, and it is easier to align a plurality of coils and improve the signal-to-noise ratio.

The sensor coil and the transmitting coil/the receiving coil may work across certain obstacles, so the sensor end may be pre-installed under the wrapper layer on the surface of the structure to be tested, which can avoid long-term disassembly and assembly of the outer wrapper layer for detecting, saving detection costs. At the same time, the position of the sensor end may not change after installation, so fixed-point monitoring can be performed.

It should be noted that there are a plurality of alternatives for the design of the coils (the sensor coil 131, the transmitting coil 211, and the receiving coil 311). For example, the shape of the coil is not limited to a single-layer, single-turn spiral coil, but may be a multi-turn, multi-layer coil, and the shape of the coil may be a square or polygonal. The coil arrangement is also not limited to the manner shown in FIG. 4, and the coil may be arranged horizontally, spaced apart, or the like. For example, the coil is designed to be conical, and m×n conical pits are formed at the sensor coil end 13. Correspondingly, m×n conical protrusions are formed at corresponding positions of the transmitting coil end 21 and the receiving coil end 31. This design not only improves the coupling effect between the coils but also facilitates the center alignment between the coils, thereby improving the detection accuracy.

In some embodiments, the controller 4 employs phased array ultrasonic detection to generate excitation signals and collect and analyze echo signals.

The controller 4 generates the excitation signals in a preset manner, transmits the excitation signals from the transmitting coils 211 of the signal transmitting module 2 to the sensor coils 131 of the sensor module 1, the sensor coils 131 excite the ultrasound sensors 113 to operate to emit ultrasonic waves; and the ultrasound sensor 113 receives the echo signals, transmits the echo signals from the sensor coils 131 to the receiving coils 311 of the signal receiving module 3, to obtain the echo signals.

According to the wireless passive ultrasound sensor array monitoring system as described above, the present disclosure provides a wireless passive ultrasound sensor array monitoring method including following operations.

In S1, affixing and securing the sensor end 11 of the sensor module 1 to the surface of the structure to be tested 6.

For a structure having a protective layer equivalent to the wrapper layer 5, the wrapper layer 5 should be removed before installation, or the sensor module 1 (e.g., the sensor end 11) should be pre-embedded during the production and processing of the structure, and then the wrapper layer 5 should be processed. Before installation, the surface of the structure to be tested 6 is polished to make it smooth, and then the sensor module 1 (for example, the sensor end 11) is firmly and evenly fixed at the position to be measured using a coupling agent, adhesive, strap or other fixing material or device. All of the ultrasound sensors 113 at the sensor end 11 need to be well coupled to the surface of the structure to be tested 6. The sensor module 1 does not move again after installation, ensuring that the position of each ultrasonic detection is completely fixed.

In some embodiments, before performing the monitoring work of S2, the wireless passive ultrasound sensor array monitoring method further includes transmitting surface detection signals to the structure to be tested 6 and receiving echo signals; determining, based on the echo signals, a roughness of the structure to be tested 6 and target treatment point(s); in response to determining that the roughness and the target treatment point(s) satisfy a sanding condition, controlling a sanding device to sand the target treatment point(s).

In some embodiments, after polishing and employing the coupling agent to install the sensor module 1 (e.g., the sensor end 11) at the position to be measured, one or more full-matrix capture (FMC) or other modes of signal transmission (i.e., transmitting the surface detection signals) and acquisition (i.e., receiving the echo signals) are performed to determine the roughness of a surface of the structure to be tested 6. In some embodiments, the wireless passive ultrasound sensor array monitoring system transmits the surface detection signals to the structure to be tested 6 and receives the echo signals, and determines, based on the echo signals, the roughness of the structure to be tested 6 and the target treatment point(s).

In some embodiments, the wireless passive ultrasound sensor array monitoring system analyzes the mean and standard deviation of signal strength of the echo signals. For example, the wireless passive ultrasound sensor array monitoring system calculates the standard deviation for each focal point based on the (m×n)² echo signals of the each focal point. More descriptions regarding the (m×n)² echo signals may be found in the related descriptions below. The focal point may be arranged on the surface of the structure to be tested 6, and the surface is a plane by default. The roughness refers to an average standard deviation of a plurality of focal points. The target treatment point refers to a focal point with a standard deviation greater than a threshold. The threshold may be set by a technician or be a system default value.

In some embodiments, the wireless passive ultrasound sensor array monitoring system determines whether the roughness and the target treatment point(s) satisfy the sanding condition. The sanding condition refers to a condition that the structure to be tested 6 needs to be sanded. The sanding condition may include that the roughness is greater than a roughness threshold and a count of the target treatment point(s) is greater than a count threshold. The roughness threshold and the count threshold may be set by the technician or be system default values.

In response to determining that the roughness and the target treatment point(s) satisfy the sanding condition, the wireless passive ultrasound sensor array monitoring system controls the sanding device to sand the target treatment point(s). The sanding device may include a sanding robot, an automatic sanding wheel, or the like. In some embodiments, the wireless passive ultrasound sensor array monitoring system controls the sanding device to move to the target treatment point(s) (e.g., moves the sanding center position of the sanding device to the target treatment point(s)) and to sand the target treatment point(s).

The roughness of the surface of the structure to be tested 6 is determined by the wireless passive ultrasound sensor array monitoring system, and the surface of the structure to be tested 6 is processed accordingly, thereby reducing the introduction of other device for detecting roughness, and at the same time ensures that the surface of the structure to be tested 6 has a good coupling effect with the sensor end 11.

In some embodiments, a sanding time of the sanding device is determined based on a roughness of the target treatment point.

In some embodiments, the sanding time of the sanding device is directly proportional to the roughness of the target treatment point. The controller may determine the sanding time of the sanding device through a preset table. The preset table includes a corresponding relationship between the sanding time and the roughness of the target treatment point. The preset table may be preset in advance by the technician according to needs.

In some embodiments, by dynamically adjusting the sanding time according to the roughness of the target treatment point, precise control is achieved, effectively avoiding the problem of insufficient or excessive sanding, thereby significantly improving the sanding quality and consistency; at the same time, the optimal sanding time is allocated to the areas with different roughness of the target treatment points, which optimizes resource utilization and improves the overall sanding efficiency.

In S2, placing the sensor coils 131 of the sensor module 1, the transmitting coils 211 of the signal transmitting module 2, and the receiving coils 311 of the signal receiving module 3 one by one in the vertical direction and in close proximity. Leads of the plurality of transmitting coils 211 and leads of the plurality of receiving coils 311 are connected to the controller 4.

The controller 4 should be equipped with a battery or connected to a power source to achieve long-term monitoring. In some embodiments, in S2, the signal transmitting module 2, the signal receiving module 3, and the controller 4, which together constitute the monitoring device, need to be fixed in a preset position.

The sensor coil array, the transmitting coil array, and the receiving coil array are all of size m×n, constituting m×n channels.

In S3, generating, by the controller 4, the excitation signals in a preset manner, transmitting the excitation signals from the transmitting coils 211 to the sensor coils 131, exciting, by the sensor coils 131, the ultrasound sensors 113 to operate to emit ultrasonic waves; and receiving, by the ultrasound sensor 113, the echo signals, transmitting the echo signals from the sensor coils 131 to the receiving coils 311, and obtaining and analyzing, by the controller 4, the echo signals.

In some embodiments, S3 is typically used for damage monitoring. The monitoring device may be controlled by a relevant person, and an initial thickness (such as initial wall thickness information, etc.), a sound velocity matrix, a detection manner, and a monitoring period of the structure to be tested 6 are preset. Analyzing the echo signals in S3 refers to analyzing the propagation characteristics of the ultrasound waves in the structure to be tested (such as a flight time, a signal amplitude, a waveform feature, and signal differences between array channels) based on the echo signals obtained by the receiving coil to detect damage, locate (depth and two-dimensional position), and quantify (size, type, severity, etc.). Ultimately, the identification, imaging, and health state assessment of internal defects (such as cracks, delamination, corrosion, etc.) of the structure are achieved, providing a basis for safety early warning and maintenance decisions of the structure.

In some embodiments, the wireless passive ultrasound sensor array monitoring system may perform continuous phased array monitoring on the surface of the structure to be tested. According to the application requirements of online monitoring, the speed of a single detection is not limited. Therefore, a channel switching circuit may be employed, and only transmit and receive signals of one transceiver pair are measured at a time, thereby reducing a count of controller channels, reducing the complexity of the device, and reducing costs.

In S3, the wireless passive ultrasound sensor array monitoring system employs a full-matrix capture manner to acquire signals, and employs a 1-transmitter, 1-receiver mode to acquire the signals. The controller selects, from the m×n channels, a channel for transmitting a signal, and after the signal is transmitted, then selects, from the m×n channels, a channel for receiving the signal, an ultrasound sensor corresponding to the channel configured to transmit the signal is a transmitting array element, and an ultrasound sensor corresponding to the channel configured to receive the signal is a receiving array element, and a signal transmitting loop corresponding to the transmitting array element and a signal receiving loop corresponding to the receiving array element form a transceiver pair, and there are a total of (m×n)² transceiver pairs to acquire (m×n)² echo signals.

In some embodiments, the wireless passive ultrasound sensor array monitoring system employs the full matrix capture manner to acquire signals, ultimately realizing a total focusing method (TEM) imaging. Since the application scenario of this embodiment is mainly the long-term monitoring of structural damage and defects, the extension of the time consumption of a single detection has little effect on the effect of long-term monitoring. Therefore, the 1-transmitter, 1-receiver mode may be used for detection, i.e., only one channel among the m×n channels is selected each time to receive or transmit signals, which can reduce costs. The controller 4 selects, from the m×n channels, a channel for transmitting the signal, and after the signal is transmitted, then selects, from the m×n channels, a channel for receiving the signal. An ultrasound sensor 113 corresponding to the channel configured to transmit the signal is the transmitting array element, and an ultrasound sensor 113 corresponding to the channel configured to receive the signal is the receiving array element, and a signal transmitting loop corresponding to the transmitting array element and a signal receiving loop corresponding to the receiving array element form the transceiver pair, and there are a total of (m×n)² transceiver pairs, and so on, so that ultimately, each of the transceiver pairs is excited in turn so as to acquire (m×n)² echo signals.

FMC refers to an ultrasonic detection data acquisition method that obtains the complete original signal matrix by traversing all possible combinations of the transmitting array elements and the receiving array elements in sequence.

The transmitting array element refers to an independent unit in the ultrasound sensor array that is responsible for generating and transmitting an ultrasonic signal. The receiving array element refers to an independent unit in the ultrasound sensor array that is responsible for receiving a reflected ultrasonic signal or a transmitted ultrasonic signal. In some embodiments, the transmitting array element works in concert with the receiving array element to achieve full-field information acquisition.

In some embodiments, the wireless passive ultrasound sensor array monitoring system employs a 1-transmitter, multiple-receiver mode or multiple-transmitter, multiple-receiver mode for detection. In the 1-transmitter, multiple-receiver mode, a count of selected channels is not limited to 1/(m×n), for example, 2/(m×n) channels are set. The two channels are selected from the m×n channels each time the signal is received, and after the transmitting coil transmits the signal, two receiving coils simultaneously detect the echo signals, which improves the efficiency of the single detection, and the more the count of channels there are, the faster the single detection speed is.

In some embodiments, a data processing process of the wireless passive ultrasound sensor array monitoring system for the echo signals is shown as follows.

In S41, before installation of the wireless passive ultrasound sensor array monitoring system, conducting experiments to obtain and record system delay data at a plurality of temperatures.

The experiments may be conducted by the technician before the installation of the wireless passive ultrasound sensor array monitoring system.

The plurality of temperatures may be at the same interval or at different intervals. A range of the plurality of temperatures may be set by the technician. The plurality of temperatures may be in the range of −50° to 50°, or other suitable ranges.

In S41, measuring total transmission times of the ultrasonic signals at different temperatures through temperature control experiments, and obtaining the system delay data increasing with temperature by deducting the theoretical sound wave propagation time from the total transmission time. The system delay data may generate temperature-delay compensation parameters, which are used to dynamically correct the ultrasonic wave propagation time measurement value according to the real-time temperature in actual monitoring to ensure monitoring accuracy in a variable temperature environment.

In S42, obtaining initial wall thickness information for the structure to be tested and inputting the initial wall thickness information into the controller 4.

The structure to be tested is a monitoring object. In some embodiments, the initial wall thickness information of the monitoring object may be obtained based on retrieving a design value and/or based on on-site measurement.

In S43, determining a monitoring area and dividing grids to form X×Y×Z focal points.

In some embodiments, according to detection condition, an area of interest (i.e., the monitoring area) is selected in an area where the phased array probe, i.e., the sensor end 11, is capable of generating sufficient acoustic pressure, and at the same time the grids are reasonably divided to form the X×Y×Z focal points.

The detection condition refers to a set of key physical parameters that affect the accuracy of ultrasonic monitoring, including acoustic characteristics (sound pressure distribution and probe frequency), material properties (sound velocity and attenuation coefficient), and environmental constraints (temperature range and structural boundaries). In some embodiments, the detection condition may be obtained according to simulation modeling, sample measurement, or standard calibration. The monitoring area refers to a sub-area of the structure to be tested that is scanned by the system within the effective sound pressure coverage of the ultrasonic phased array. In some embodiments, the monitoring area may be determined by measuring an area that meets the required sound pressure.

In some embodiments, the controller may determine preset focal points data and values of X, Y, and Z based on information about the area of interest of the structure to be tested 6, material properties of the structure to be tested 6, and probe data.

The information about the area of interest refers to information about the size, shape, etc., of the area of interest.

In some embodiments, the information about the area of interest may be obtained by technicians inputting manually selected area(s) of interest as needed.

The probe data refers to parameters such as a count of the probes, arrangement, and a count of the channels (mx n). The probe data may be pre-stored in the controller, and the controller may directly read and obtain the probe data.

The preset focal point data refers to relatively better relevant data about the focal point. For example, the preset focal point may include parameters such as the count of the focal points that need to be preset, the arrangement of the focal points, or the like. The corresponding values of X, Y, and Z may be determined according to the arrangement of the focal points.

In some embodiments, the preset focal point data may be determined according to a vector database. The controller may construct the vector database based on historical data, and the vector database includes a plurality of reference vectors and reference focal point data corresponding to each reference vector. The controller may generate a target feature vector based on the information about the area of interest, the material properties, and the probe data of a current structure to be tested, obtain a reference vector corresponding to the highest similarity from the vector database based on vector similarity matching, and designate reference focal point data corresponding to the reference vector as the preset focal point data.

In some embodiments, determining the preset focal point data based on a plurality of pieces of data, such as the information about the area of interest, the material properties of the structure to be tested 6, the probe data, etc. The influence of the plurality of pieces of data on the focal point can be considered, which is conducive to determining more appropriate focal points, thereby improving the efficiency and accuracy of the grid scanning.

More descriptions regarding the material properties of the structure to be tested may be found elsewhere in the present disclosure (e.g., S453 and related descriptions thereof).

In S44, recording a sound velocity matrix for each of the X×Y×Z focal points at each of the plurality of temperatures. The sound velocity matrix includes sound velocities of (m×n)² transceiver pairs.

In some embodiments, a short time range may be set, and within the shorter time range, it is considered that the wall thickness of the structure to be tested 6 has not changed significantly. A temperature sensor may be provided in the sensor module 1 or the controller 4 to perform temperature measurements. When factors such as day and night temperatures and equipment operation cause temperature changes, the sound velocity matrix is calculated and recorded.

The purpose of recording the sound velocity matrix of the each focal point at the plurality of temperatures is: during the monitoring process, temperature changes will affect the ultrasonic sound velocity, which may lead to changes in the TFM imaging; at the same time, for the monitoring of non-homogeneous structures such as weld locations, the sound velocities in all directions are also different, which may cause misjudgment. Since the position of the focal point does not change during the long-term monitoring, and the corresponding relationship between the sound velocity and angle at a specific point on the structure to be tested 6 does not change when the temperature is constant, the sound velocity matrix of the each focal point at the plurality of temperatures may be recorded in advance, and the sound velocity matrix of the each focal point at the current temperature can be directly retrieved or interpolated in the subsequent data processing.

A manner for calculating the sound velocity corresponding to the angle is as follows: a group velocity distribution at small angles is obtained by the bottom reflectance manner (BRM), and at the same time an extrapolation prediction of the group velocity distribution in the direction of the large angle is performed by combining with the Christoffel equation to form the sound velocity matrix of a single focal point, and then the above process is repeated until the formation of the sound velocity matrix of the X×Y×Z focal points. Details are as follows.

Obtaining the sound velocity distribution v(θ) at the small angles by the BRM is according to equation:

$$v ( θ ) = 2 h / ( {t}_{θ} \times cos θ ) ;$$

where h denotes the initial wall thickness of the structure to be tested 6; t₀ the denotes a time for the bottom surface (i.e., a surface of the structure to be tested 6 opposite to the surface to which the ultrasound sensor is affixed) reflecting the echo back to the receiving array element when the angle of incidence is θ; and θ denotes an angle of incidence;

$$θ = arctan ( Δ \times p / 2 h ) ;$$

where p denotes an array pitch; Δ denotes a distance between a transmitting array element and a receiving array element;

$$Δ = p \times \sqrt{{( {R}_{i} - {T}_{i} )}^{2} + {( {R}_{j} - {T}_{j} )}^{2}} ;$$

where the transmitting array element is (Rᵢ, Rⱼ), Rᵢ denotes a row number of a transmitting coil 211 corresponding to the transmitting array element in a transmitting array (also referred to as the transmitting coil array), Rⱼ denotes a column number of the transmitting coil 211 corresponding to the transmitting array element in the transmitting array; the receiving array element is (Tᵢ, Tⱼ), Tᵢ denotes a row number of a receiving coil 311 corresponding to the receiving array element in a receiving array (also referred to as the receiving coil array), Tⱼ denotes a column number of the receiving coil 311 corresponding to the receiving array element in the receiving array, 1≤Rᵢ, Tᵢ≤m, 1≤Rⱼ, Tⱼ≤n.

Extrapolating the group velocity distribution at the direction of the large angle via the Christoffel equation to determine the sound velocity distribution v(θ) of the quasi-longitudinal wave. The equation is:

$$v ( θ ) = \sqrt{\frac{A + \sqrt{{A}^{2} - 4 B}}{2 ρ}} ;$$

where ρ denotes a density of the material; A and B denote both intermediate variables;

$$\begin{matrix}A = {C}_{11} {cos}^{2} θ + {C}_{33} {sin}^{2} θ + {C}_{44} ; \\ B = ( {C}_{11} {cos}^{2} θ + {C}_{44} {sin}^{2} θ ) ( {C}_{11} {sin}^{2} θ + {C}_{44} {cos}^{2} θ ) - {( {C}_{13} + {C}_{44} )}^{2} {sin}^{2} θ {cos}^{2} θ ;\end{matrix}$$

where C₁₁, C₁₃, C₃₃, and C₄₄ denote four independent elastic constants.

The sound velocity matrix is formed for a single focal point. The each focal point receives echo signals from the (m×n)² transceiver pairs, and an angle of the sound beam of each transceiver pair at the focal point may be calculated based on position information of the sensor. Actual sound velocities of the sound beams of the (m×n)² transceiver pair may be obtained based on the derived equation for the sound velocity corresponding to the angle, with the each focal point forming a sound velocity matrix of size (m×n)².

S45, monitoring in the manner described in S3, in the monitoring period, after each transceiver pair completes one signal transceiver, recording a signal strength induced by the signal transceiver at each focal point; after completing the signal transceiver of the (m×n)² transceiver pairs, obtaining (m×n)² signal strength data at the each focal point; the wireless passive ultrasound sensor array monitoring system determines a signal integral response based on the (m×n)² signal strength data obtained at the each focal point during a calculation process to obtain a final signal strength at the each focal point for imaging at S46, the calculation process is shown below.

In S451, obtaining a current temperature value.

In some embodiments, the current temperature value is obtained by the temperature sensor.

In S452, obtaining a system delay value t′ at the current temperature value based on the recorded system delay data at the plurality of temperatures.

In some embodiments, the system delay value t′ at the current temperature value is obtained based on the recorded system delay data at the plurality of temperatures by an interpolation manner, or the like.

In S453, selecting a transceiver pair for the one signal transceiver, the transmitting array element is (Rᵢ, Rⱼ), Rᵢ denotes the row number of the transmitting coil corresponding to the transmitting array element in the transmitting array, and Rⱼ denotes a column number of the transmitting coil corresponding to the transmitting array element on the transmitting array; the receiving array element is (Tᵢ, Tⱼ), Tᵢ denotes the row number of the receiving coil corresponding to the receiving array element on the receiving array, Tⱼ denotes the column number of the receiving coil corresponding to the receiving array element on the receiving array, 1≤Rᵢ, Tᵢ≤m, 1≤Rⱼ, Tⱼ≤n.

More descriptions regarding the (Rᵢ, Rⱼ) and (Tᵢ, Tⱼ) may be found elsewhere in the present disclosure (e.g., S44 and related descriptions thereof).

In some embodiments, the wireless passive ultrasound sensor array monitoring system further includes a barometric pressure sensor and a humidity sensor. The barometric pressure sensor is configured to obtain barometric pressure data. The humidity sensor is configured to obtain humidity data. The barometric pressure sensor realizes pressure measurement according to the deformation or charge change of a pressure-sensitive element, such as a piezoelectric crystal. The humidity sensor may include a capacitive sensor or a resistive sensor. The barometric pressure sensor and the humidity sensor may be placed at preset positions, such as the controller 4, the sensor module 1, the surface of the structure to be tested 6, the surface of the wrapper layer 5, etc.

In some embodiments, the barometric pressure sensor acquires barometric pressure data at a current time point and sends the barometric pressure data to the controller 4. The humidity sensor acquires humidity data at the current time point and sends the humidity data to the controller 4. The temperature sensor acquires temperature data at the current time point and sends the temperature data to the controller 4. In some embodiments, before S454, the wireless passive ultrasound sensor array monitoring method further includes determining whether temperature data and/or the material properties of the structure to be tested 6 satisfy a preset condition. The temperature data includes a current temperature value corresponding to the current time point and temperature values of the plurality of temperatures in S44. The material property refers to the type of material of the structure to be tested 6. The material property may be determined by a technician entering or selecting in advance. The preset condition refers to that a variance or standard deviation (discreteness) of a plurality of temperature values (i.e., the current temperature value and the temperature values of the plurality of temperatures) in the temperature data exceeds a threshold, and/or a material type of the structure to be tested 6 is a non-homogeneous material, a composite material, etc. The threshold may be set by the technician or be a system default value.

In response to determining that the temperature data and/or the material properties of the structure to be tested 6 satisfy the preset condition, the sound velocity matrix of the focal point at the current temperature is determined by a sound velocity model based on sound velocity matrix of the each focal point at the plurality of temperatures (i.e., the sound velocity matrix of each of the X×Y×Z focal points described in S44 at each of the plurality of temperatures), the temperature data (including the current temperature and the plurality of temperatures), the barometric pressure data at the plurality of temperatures, the humidity data at the plurality of temperatures, barometric pressure data at the current temperature, humidity data at the current temperature, and the material properties of the structure to be tested. The sound velocity model is a machine learning model. In response to determining that the temperature data and/or the material properties of the structure to be tested 6 do not satisfy the preset condition, the interpolation manner in S454 described below is performed to obtain a sound velocity matrix of the focal point at the current temperature value.

The sound velocity model refers to a model that is configured to determine a sound velocity matrix of a focal point in a structure to be tested at the current temperature. The sound velocity model may be a deep neural network (DNN) model, etc., or any one or combination of other customized model structures.

In some embodiments, the sound velocity model may be obtained by training based on first training samples with first labels. Each set of the first training samples includes a sound velocity matrix of each focal point at a plurality of sample temperatures of a detection sample, sample temperature data (including a current sample temperature of the detection sample and the plurality of sample temperatures), sample humidity data at the plurality of sample temperatures, and sample barometric pressure data at the plurality of sample temperatures, current sample barometric pressure data at the current sample temperature, current sample humidity data at the current sample temperature, and material properties of the detection sample. The detection sample may include a plurality of material types. The first label is a sample sound velocity matrix of the focal point at the current sample temperature of the detection sample corresponding to the first training sample. The first training sample(s) and the first label(s) are obtained by the technician employing the wireless passive ultrasound sensor array monitoring system to detect the detection sample(s) at the plurality of sample temperatures and the current sample temperature.

In some embodiments, the wireless passive ultrasound sensor array monitoring system may input one or more first training samples into an initial sound velocity model to obtain an output of the initial sound velocity model; calculating a value of a loss function based on the output of the initial sound velocity model and first label(s) corresponding to the one or more first training samples by substituting into an equation for a predefined loss function; reversely update model parameters in the initial sound velocity model based on the value of the loss function, and an updating manner of the model parameters may include a gradient descent method, or the like; when an iteration completion condition is satisfied, the model training is completed, and a trained sound velocity model is obtained. The iteration completion condition may include that the value of the loss function is less than a loss threshold, a count of the iterations reaches a maximum count, or the like.

The sound velocity matrix at the current conditions determined by employing the sound velocity model takes into account the influence of a plurality of conditions and parameters, and can accurately predict the sound velocity matrix of the focal points with large temperature differences and outside the material type range, thereby improving the imaging quality and enhancing the reliability of the overall detection system.

In S454, calculating an ultrasound flight time of the each focal point during the signal transceiver. An ultrasound flight time of a focal point (x,y,z) is calculated as follows.

The sound velocity matrix of the focal point (x,y,z) at the current temperature value is obtained by the interpolation manner based on the sound velocity matrices of the each focal point at the plurality of temperatures, and sound velocity of the transceiver pair v(Rᵢ, Rⱼ, Tᵢ, Tⱼ,x,y,z) is obtained by querying the sound velocity matrix of the focal point (x,y,z) at the current temperature value.

The ultrasound flight time t(Rᵢ,Rⱼ, Tᵢ,Tⱼ,x,y,z) at the focal point (x,y,z) is calculated as:

$$t ( {R}_{i} , {R}_{j} , {T}_{i} , {T}_{j} , x , y , z ) = L ( {R}_{i} , {R}_{j} , {T}_{i} , {T}_{j} , x , y , z ) / v ( {R}_{i} , {R}_{j} , {T}_{i} , {T}_{j} , x , y , z ) ;$$

L(Rᵢ,Rⱼ,Tᵢ,Tⱼ,x,y,z) denotes an acoustic path length of an ultrasound which is emitted from the transmitting array element (Rᵢ, Rⱼ), passes through the focal point (x,y,z) and then arrives at the receiving array element (Tᵢ, Tⱼ); 1≤x≤X, 1≤y≤Y, and 1≤z≤Z.

In S455, calculating the signal strength of the each focal point based on echo signals obtained from the signal transceiver. For the focal point (x,y,z), a moment t_{f} of arrival of the echo signals is selected, from data segment of the echo signals, based on the ultrasound flight time of the focal point (x,y,z), and a signal strength of a moment (t_{f}+t′) is recorded as the signal strength H(Rᵢ,Rⱼ,Tᵢ,Tⱼ,x,y,z) of the focal point (x,y,z).

In some embodiments, S455 is calculated as:

$$H ( {R}_{i} , {R}_{j} , {T}_{i} , {T}_{j} . x , y , z ) = {h ( t )}_{{R}_{i} {R}_{j} , {T}_{i} , {T}_{j}} {\vert}_{t f + t} ;$$

where h(t)_{R}_{ᵢ}_{,R}_{ⱼ}_{,T}_{ᵢ}_{,T}_{ⱼ} denotes the Hilbert transform of the ultrasound A-scan echo signals.

In S456, repeating S453-S455 until signal transceivers of all of the transceiver pairs is completed, and (m×n)² signal strength data are obtained at the each focal point.

In S467, accumulating the (m×n)² signal strength data at the each focal point, calculating the signal integral response for the each focal point to obtain the final signal strength for the each focal point. The final signal strength I(x,y,z) of the focal point (x,y,z) is:

$$I ( x , y , z ) = {\sum }_{{R}_{j} , {R}_{j} , {T}_{i} , {T}_{j}} \vert H ( {R}_{i} , {R}_{j} , {T}_{i} , {T}_{j} , x , y , z ) \vert$$

In S46, performing a total-focus imaging to form X×Y×Z pixel points, mapping the final signal strength at the each focal point to a corresponding pixel value, and generating a total-focus image.

In some embodiments, the wireless passive ultrasound sensor array monitoring method further includes: generating, based on the echo signals received by the ultrasound sensor, a current sound velocity matrix, the probe data, the temperature data, the humidity data, the barometric data, and the material properties, the total-focus image by an image generation model.

In some embodiments, the image generation model refers to a machine learning model that is configured to generate a total-focus image of the structure to be tested. The image generation model may be a machine learning model, for example, a convolutional neural network (CNN) model, or one or a combination of other customized model structures.

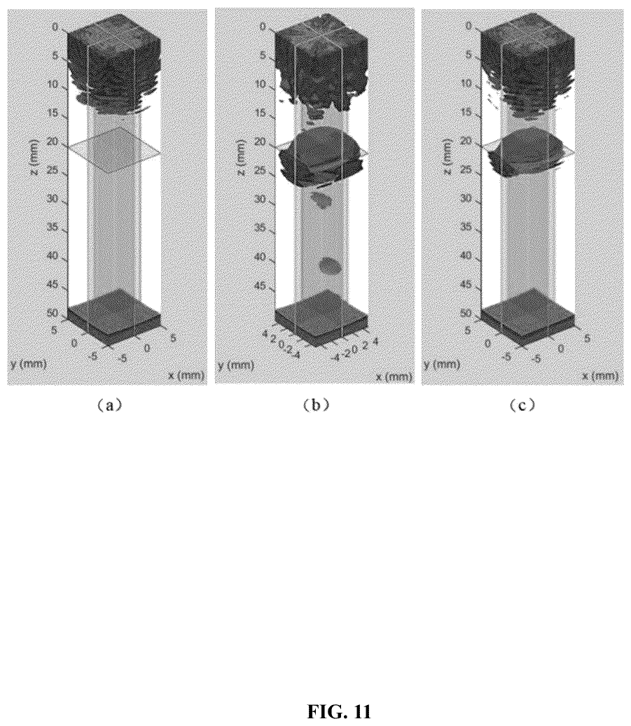

In some embodiments, the image generation model is obtained based on second training samples with second labels, and each set of the second training samples includes: sample echo signals received by the ultrasound sensor, a sample sound velocity matrix, sample probe data, sample temperature data, sample humidity data, sample barometric pressure data, and sample material properties of the detection sample. The second label is a sample total-focus image corresponding to the second training sample. The second training sample may be obtained from historical data. The second label is an actual total-focus image corresponding to the second training sample, such as the total-focus image shown in FIG. 11.

The training process of the image generation model is similar to that of the sound velocity model. More descriptions regarding the training process of the image generation model may be found elsewhere in the present disclosure (e.g., the training process of the sound velocity model and related descriptions thereof).

In some embodiments, the echo signals may be data after denoising. More descriptions regarding the echo signals, the sound velocity matrix, the probe data, the temperature data, the humidity data, the barometric pressure data, and the material properties may be found in the related descriptions below.

The total-focus image refers to an image generated by an imaging manner in ultrasonic phased array detection (or other array detection technologies). The total-focus image represents the strength or amplitude information of ultrasonic reflectors (e.g., defects and interfaces) at each pixel point (or voxel) within a specified imaging area.

In some embodiments, an input of the image generation model further includes sensor position information. The sensor position information includes three-dimensional spatial coordinates of the transmitting/receiving array elements and an array topology relationship. The sensor position information may be pre-stored in the controller.

In some embodiments, when the input of the image generation model includes the sensor position information, the second training sample also include sample sensor position information.

The total-focus image is generated based on the echo signals, the sound velocity matrix, the probe data, the temperature data, the humidity data, the barometric pressure data, the material properties, etc., by the image generation model, which can take into account the effects of a plurality of factors on the generation of the total-focus image and can improve the accuracy and efficiency of the total-focus image.

In some embodiments, the imaging manner of the monitoring system of the present disclosure is not limited to the total-focus imaging, and all phased-array single point acquisition imaging modalities, such as fan-sweep imaging, plane-wave imaging, wave-number-domain imaging, etc., may be performed when sufficient channels are available.

In some embodiments, a baseline manner may be employed to remove inherent geometric features, and a single total-focus imaging may be performed after installation of the monitoring system and recorded as initial imaging data, that is as a structural feature when the defect is not occurring or developing. After that, the initial imaging data is subtracted from each total-focus imaging data, retaining only changed structural features, eliminating interference of the inherent geometric features, and highlighting defect positions. A strength SI(a,x,y,z) at the focal point (x,y,z) after baseline subtraction in the a-th total-focus imaging is calculated as:

$$SI ( a , x , y , z ) = \vert \frac{I ( a , x , y , z )}{max ( I ( a , x , y , z ) )} - \frac{I ( 1 , x , y , z )}{max ( 1 ( a , x , y , z ) )} \vert ;$$

where I(1,x,y,z) and I(a,x,y,z) denote the final signal strength obtained at the focal point (x,y,z) in the 1st and a-th total-focus imaging, respectively, and max(•) denotes the maximum function.

In some embodiments, an alternative calculation manner for the baseline manner is as follows. A bottom wave signal is stronger at a defect-free area, and when a defect occurs, the ultrasonic beam is blocked by the defect, and the bottom wave signal may be weakened. If the above equation is employed, after subtraction, an image strength of the bottom wave is negative, and then an absolute value is taken, and the image strength at the bottom surface is instead enhanced. In some embodiments, the following calculation may be used instead:

$$SI ( a , x , y , z ) = \{ \begin{matrix}\vert \frac{I ( a , x , y , z )}{max ( I ( a , x , y , z ) )} - \frac{I ( 1 , x , y , z )}{max ( 1 ( a , x , y , z ) )} \vert , ( \frac{I ( a , x , y , z )}{max ( I ( a , x , y , z ) )} - \frac{I ( 1 , x , y , z )}{max ( 1 ( a , x , y , z ) )} > 0 ) \\ 0 , ( \frac{I ( a , x , y , z )}{max ( I ( a , x , y , z ) )} - \frac{I ( 1 , x , y , z )}{max ( 1 ( a , x , y , z ) )} \leq 0 )\end{matrix} ;$$

where SI(a,x,y,z) denotes a final signal strength obtained after baseline subtraction at the focal point (x,y,z) in the a-th total-focus imaging.

In some embodiments, an 8×8 probe is employed to monitor defects in a weld seam of an aluminum workpiece, and an area of interest is set to be 10 mm×10 mm×50 mm, and a total of 1799637 (=71×71×357) focal points are taken. A signal strength calculation at a focal point (3,4,5) is calculated as follows.

The 8×8 probe is numbered, and for the ultrasound sensor in the a-th row and the b-th column is numbered 8×(a−1)+b. For example, the ultrasound sensor in the 1st row and the 2nd column is numbered 2, and the ultrasound sensor in the 3rd row and the 4th column is numbered 20 (=8×(3−1)+4). There are 64 ultrasound sensors, so the size of the sound velocity matrix is 64×64. When the monitoring system is initially operated, two matrices recorded at 9.0° C. and 9.5° C. are selected from the sound velocity matrices of the focus (3,4,5) at 25 temperature values according to the current temperature value of 9.2° C. during detection, and obtain a sound velocity matrix of the focal point (3,4,5) at 9.2° C. based on the interpolation manner. The sound velocity matrix records the corresponding sound velocity of all the transceiver pairs, for example, when the ultrasound sensor numbered 2 transmits and the ultrasound sensor numbered 20 receives, the value of the 2nd row and 20th column of the sound velocity matrix should be selected, and the value of the sound velocity is 6150.3 m/s. According to the signal strength equation, the signal strength at the focal point (3,4,5) is calculated as H(1,2,3,4,3,4,5)=5.50×10⁻³. The measurement is repeated 64×64 times, and 4096 signal strength data may be obtained at the focal point (3,4,5), which may be totalized according to a totalization equation to obtain the final signal strength I(3,4,5)=22.51 at the focal point (3,4,5).

The maximum value Imax (36,44,157)=58.68 is selected from the strength data of 1799637 focal points, and the strengths of all of the focal points are normalized according to the maximum value. For example, the strength of the focal point (3,4,5) after normalization is calculated as:

$$20 * lg \vert \frac{I ( 3 , 4 , 5 )}{I ( 36 , 44 , 157 )} \vert = - 8.322 ;$$

The strength of the each focal point is mapped to the image color, forming 1799637 (71×71×357) pixel points, and finally, the total-focus image is obtained, as shown in (a) in FIG. 11.

FIG. 11 is total-focus images according to some embodiments of the present disclosure, (a) denotes an initial (first detection) total-focus image obtained, (b) denotes a total-focus image obtained after 1 year, and (c) denotes a processed image obtained based on the baseline subtraction.

The total-focus image is obtained in the same way after 1 year, as shown in (b) in FIG. 11. The processed image is obtained based on the baseline subtraction, as shown in (c) in FIG. 11. It can be seen that the image after the baseline subtraction suppresses the interfering signals and highlights the defect position.

The above descriptions only represent preferred embodiments of the present disclosure, not intended to limit the scope of the present disclosure. Any modifications, equivalent substitutions, or improvements made within the spirit and scope of the present disclosure shall be deemed to fall within the protection scope of the present disclosure.

What is claimed is:

1. A wireless passive ultrasound sensor array monitoring system, wherein the wireless passive ultrasound sensor array monitoring system comprises: a sensor module, a signal transmitting module, a signal receiving module, and a controller;
the sensor module including a sensor end and a sensor coil end, wherein the sensor end is arranged with an ultrasound sensor array, the sensor coil end is arranged with a sensor coil array, a size of the ultrasound sensor array is the same as a size of the sensor coil array, and ultrasound sensors in the ultrasound sensor array and sensor coils in the sensor coil array at corresponding positions are connected one by one;
the signal transmitting module including a transmitting coil end, wherein the transmitting coil end is arranged with a transmitting coil array, a size and an arrangement of the transmitting coil array is the same as the size and an arrangement of the sensor coil array, and transmitting coils in the transmitting coil array and the sensor coils in the sensor coil array are one by one correspond in a vertical direction; leads of the transmitting coils in the transmitting coil array are all connected to the controller;
the signal receiving module including a receiving coil end, wherein the receiving coil end is arranged with a receiving coil array, a size and an arrangement of the receiving coil array is the same as the size and the arrangement of the sensor coil array, and receiving coils in the receiving coil array and the sensor coils in the sensor coil array are one by one correspond in the vertical direction; leads of the receiving coils in the receiving coil array are all connected to the controller;
wherein a set of a sensor coil, a transmitting coil. and a receiving coil corresponding in the vertical direction constitute a channel, the channel being configured to transmit or receive a signal;
wherein the controller employs phased array ultrasonic detection, and generates excitation signals and collects and analyzes echo signals; and
wherein the sensor end of the sensor module is affixed to a surface of a structure to be tested; the sensor coil end, the transmitting coil end, and the receiving coil end are in close proximity to each other, and center positions of the set of the sensor coil, the transmitting coil, and the receiving coil corresponding in the vertical direction correspondingly coincide one by one in the vertical direction, realizing ultrasonic detection of the structure to be tested.

2. The wireless passive ultrasound sensor array monitoring system of claim 1, wherein an outer diameter of the receiving coils is smaller than an inner diameter of the transmitting coils, or an outer diameter of the transmitting coils is smaller than an inner diameter of the receiving coils, the receiving coils and the transmitting coils do not overlap in the vertical direction.

3. The wireless passive ultrasound sensor array monitoring system of claim 1, wherein an electromagnetic shielding material is affixed to a side of the sensor coil end facing the structure to be tested.

4. The wireless passive ultrasound sensor array monitoring system of claim 1, wherein the wireless passive ultrasound sensor array monitoring system further comprises a temperature sensor configured to collect temperature information and send the temperature information to the controller; and the controller is configured to perform real-time sound velocity correction based on the temperature information.

5. The wireless passive ultrasound sensor array monitoring system of claim 1, wherein the sensor module, the signal transmitting module, and the signal receiving module employ a non-metallic material as a substrate.

6. The wireless passive ultrasound sensor array monitoring system of claim 1, wherein the leads of the transmitting coils of the signal transmitting module are led through a transmitting lead end, the transmitting lead end is provided with a plurality of front transmitting pads and a plurality of back transmitting pads corresponding to a count of the transmitting coils, and transmitting front leads and transmitting back leads of the transmitting coils are correspondingly connected to the plurality of front transmitting pads and the plurality of back transmitting pads; the leads of the receiving coils of the signal receiving module are led through a receiving lead end, and the receiving lead end is provided with a plurality of front receiving pads and a plurality of back receiving pads corresponding to a count of the receiving coils, and receiving front leads and receiving back leads of the receiving coils are correspondingly connected to the plurality of front receiving pads and the plurality of back receiving pads.

7. A wireless passive ultrasound sensor array monitoring method, wherein, based on the wireless passive ultrasound sensor array monitoring system of claim 1, the wireless passive ultrasound sensor array monitoring method comprises:
S1, affixing and securing the sensor end of the sensor module to the surface of the structure to be tested;
S2, placing the sensor coils of the sensor module, the transmitting coils of the signal transmitting module, and the receiving coils of the signal receiving module one by one in the vertical direction and in close proximity, wherein the leads of the transmitting coils and the leads of the receiving coils are connected to the controller;
wherein the sensor coil array, the transmitting coil array, and the receiving coil array are all of size m×n, constituting m×n channels; and
S3, generating the excitation signals by the controller in a preset manner, transmitting the excitation signals from the transmitting coils to the sensor coils, exciting the ultrasound sensors to operate to emit ultrasonic waves by the sensor coils; and receiving the echo signals by the ultrasound sensor, transmitting the echo signals from the sensor coils to the receiving coils, to obtain the echo signals.

8. The wireless passive ultrasound sensor array monitoring method of claim 7, wherein in S3, the wireless passive ultrasound sensor array monitoring system employs a full-matrix capture manner to acquire signals, and employs a 1-transmitter, 1-receiver mode to acquire the signals, and the controller selects a channel for transmitting a signal from the m×n channels, and after the signal is transmitted, then selects a channel for receiving the signal from the m×n channels, wherein an ultrasound sensor corresponding to the channel configured to transmit the signal is a transmitting array element, and an ultrasound sensor corresponding to the channel configured to receive the signal is a receiving array element, and a signal transmitting loop corresponding to the transmitting array element and a signal receiving loop corresponding to the receiving array element form a transceiver pair, and there are a total of (m×n)² transceiver pairs to acquire (m×n)² echo signals.

9. The wireless passive ultrasound sensor array monitoring method of claim 8, wherein a data processing process includes:
S41, before installation of the wireless passive ultrasound sensor array monitoring system, conducting experiments to obtain and record system delay data at a plurality of temperatures;
S42, obtaining initial wall thickness information for the structure to be tested and inputting the initial wall thickness information into the controller;
S43, determining a monitoring area and dividing grids to form X×Y×Z focal points;
S44, recording a sound velocity matrix for each of the X×Y×Z focal points at each of the plurality of temperatures, the sound velocity matrix including sound velocities of the (m×n)² transceiver pairs;
S45, monitoring in the manner described in S3, in a monitoring period, after each transceiver pair completes one signal transceiver, recording a signal strength induced by the signal transceiver at each focal point; after completing the signal transceiver of the (m×n)² transceiver pairs, obtaining (m× n) 2 pieces of signal strength data at the each focal point; wherein the wireless passive ultrasound sensor array monitoring system determines a signal integral response based on the (m×n) 2 pieces of signal strength data obtained at the each focal point during a calculation process to obtain a final signal strength at the each focal point, the calculation process includes:
S451, obtaining a current temperature value;
S452, obtaining a system delay value t′ at the current temperature value based on the recorded system delay data at the plurality of temperatures;
S453, selecting a transceiver pair for the one signal transceiver, wherein the transmitting array element is (Rᵢ, Rᵢ), Rᵢ is a row number of a transmitting coil corresponding to the transmitting array element in a transmitting array, and Rᵢ is a column number of the transmitting coil corresponding to the transmitting array element in the transmitting array; the receiving array element is (Tᵢ, Tᵢ), Tᵢ is a row number of a receiving coil corresponding to the receiving array element in a receiving array, Tis a column number of the receiving coil corresponding to the receiving array element in the receiving array, 1≤Rᵢ, Tᵢ≤m, 1≤Rⱼ, Tⱼ≤n;
S454, calculating an ultrasound flight time of the each focal point during the signal transceiver, wherein an ultrasound flight time of a focal point (x,y,z) is calculated as:
obtaining, based on sound velocity matrices of the each focal point at the plurality of temperatures, the sound velocity matrix of the focal point (x,y,z) at the current temperature value by an interpolation manner, and querying, from the sound velocity matrix of the focal point (x,y,z) at the current temperature value, to obtain a sound velocity of the transceiver pair v(Rᵢ, Rⱼ, Tᵢ, Tⱼ,x,y,z);
the ultrasound flight time t(Rⱼ, Rⱼ, Tᵢ, Tⱼ,x,y,z) of the focal point (x,y,z) is calculated as:
$$t ( {R}_{i} , {R}_{j} , {T}_{i} , {T}_{j} , x , y , z ) = L ( {R}_{i} , {R}_{j} , {T}_{i} , {T}_{j} , x , y , z ) / v ( {R}_{i} , {R}_{j} , {T}_{i} , {T}_{j} , x , y , z ) ;$$
where L(Rⱼ, Rⱼ, Tᵢ, Tⱼ,x,y,z) is an acoustic range of an ultrasound which is emitted from the transmitting array element (Rᵢ, Rᵢ), passes through the focal point (x,y,z) and then arrives at the receiving array element (Tᵢ, Tⱼ); 1≤x≤X, 1≤y≤Y, 1≤z≤Z;
S455, calculating the signal strength of the each focal point based on echo signals obtained from the signal transceiver, wherein, for the focal point (x,y,z), a moment t_{f} of arrival of the echo signals in data segment of the echo signals is selected based on the ultrasound flight time of the focal point (x,y,z), and a signal strength of a moment (t_{f}+t′) is recorded as the signal strength H(Rⱼ, Rⱼ, Tᵢ, Tⱼ,x,y,z) of the focal point (x,y,z);
S456, repeating S453-S455 until signal transceivers of all of the transceiver pairs are completed, the (m×n) 2 pieces of signal strength data being obtained at the each focal point; and
S457, accumulating the (m× n) 2 pieces of signal strength data at the each focal point, calculating the signal integral response for the each focal point to obtain the final signal strength for the each focal point, wherein the final signal strength I(x,y,z) of the focal point (x,y,z) is:
$$I ( x , y , z ) = {\sum }_{{R}_{i} , {R}_{j} , {T}_{i} {T}_{j}} H ( {R}_{i} , {R}_{j} , {T}_{i} , {T}_{j} , x , y , z ) ;$$
S46, performing a total-focus imaging to form X×Y×Z pixel points, mapping the final signal strength at the each focal point to a corresponding pixel value, and generating a total-focus image.
